(19) United States
(12) Patent Application Publication
(10) Pub. No.: US 2025/0308274 A1
(43) Pub. Date: Oct. 2, 2025

(54) METHOD AND APPARATUS TO CREATE STRUCTURED DOCUMENTS AND GENERATE CONTENT

(71) Applicant: KONICA MINOLTA BUSINESS SOLUTIONS U.S.A., INC., Foster City, CA (US)

(72) Inventor: Junchao WEI, San Mateo, CA (US)

(21) Appl. No.: 18/622,846

(22) Filed: Mar. 29, 2024

(51) Int. Cl. G06V 30/19; G06V 30/14; G06V 30/412

(52) U.S. Cl. CPC G06V 30/19147; G06V 30/1448; G06V 30/412

(57) ABSTRACT

A semantic diffusion model may generate semi-structured data using existing character image creations. Form image generation is one area of possible application. Embodiments include both training the diffusion model and using the diffusion model. The model can learn to permute and rearrange character features for different regions. Newly generated forms can be applied to train the semantic diffusion model to provide further improvements to the model's capability and generality. The model can generate high quality character-like images that incorporate geometric properties such as character locations and regions of similar meaning, which humans can check and/or interpret. Embodiments are suitable for semi-structured data such as forms, tables, and aligned keyword text generation, and resolve the issue of generating data for mixed and combined geometries and semantics. There also is applicability to hybrid or multimodality datasets, so long as the raw data can be interpreted and converted as character-like image tensors.

### CROSS-REFERENCE TO RELATED APPLICATIONS

The present application is related to U.S. application Ser. No. 17/958,262, filed Sep. 30, 2022, entitled “Method and Apparatus for Form Identification and Registration”; U.S. application Ser. No. 18/128,951, filed Mar. 30, 2023, entitled “Method and Apparatus for Form Identification and Registration Employing Predefined Text Grouping”; and U.S. application Ser. No. 18/409,739, filed Sep. 29, 2023, entitled “Method and Apparatus to Generate and Augment Document Forms”. The present application incorporates by reference all of these US applications in their entirety.

### BACKGROUND OF THE INVENTION

In document processing, there are increasing demands for an appropriate dataset to train a deep learning model to recognize and work with a wide variety of documents such as bills, receipts, invoices, and medical forms. Such documents often can contain private data which should not be part of training of a model. In addition, it can be difficult to acquire enough real data to train a model adequately. Consequently, there have been efforts to generate synthetic training data, or augmented data for training. However, creating such data can be challenging. Manipulating data to create artificial training data can require complicated algorithms and also can require limits on variations of the generated artificial data.

Various algorithms and methods, such as the ones described in the above-referenced US applications, can augment form data from identified text (for example, text contained in bounding boxes) and OCR engine output. One such method takes a group of identified bounding boxes and the associated semantic text as an input.

Moving within various ones of the group of bounding boxes, contents inside can be modified. However, this method requires defining a target group of bounding boxes and utilizes manual labeling for different types of documents. If the semantic group were not unique and deterministic, the augmentation and generation could be incorrect and not representative, rendering the resulting generated data inadequate for training a model.

In another sense, as customer datasets accumulate and grow, it can be more and more inefficient to apply algorithms to augment the documents, because various possibly distinct regions in the forms actually may become ambiguous and less clear.

Another approach provides a semantic model to create a text image from bounding boxes and its semantic information, as one of the above-referenced patent applications discusses. Yet another approach introduces pre-defined groups and class definitions for the semantic model, as another of the above-referenced patent applications discloses. This approach defines eight generic regions for various types of forms, and a labeling strategy for different regions. Text-image creation enables those potential applications, with extension for semantic region detection and data-labeling, and provides a related data-driven approach. However, there is no direct approach and method to generate semi-structured data extracted from image and text. Known approaches include pure text generation and direct natural image creation.

It would be desirable to create a fully automated end-to-end data generation scheme to provide a more diverse dataset.

### SUMMARY OF THE INVENTION

To address the foregoing and other limitations, in an embodiment a diffusion model may be provided for semi-structured data generation using existing character image creations. Diffusion models have been applied successfully in a number of areas, including for example Al-based image creators such as midjourney. Compared to a generative adversarial network (GAN) approach, diffusion models are relatively easy to train, and provide better convergence. Diffusion models also provide more details and higher resolution (higher quality) images. Moreover, diffusion models provide a larger number of variations, and greater diversity of generated data. Further diffusion models make it easier to control data generation using previously generated information.

One aspect of diffusion model applications is a focus on image generation, particularly RGB image generation. The dataset in use is not image intuitive and semi-structured data. Accordingly, in order to connect the dataset and use it properly it is necessary first to convert the dataset to an image-like dataset using one of the approaches from the above-mentioned patent applications, and then accommodate and apply the dataset as raw image input. In this manner, it is possible to develop character embedding to a pseudo pixel converter and inverter to connect the semantic model to a diffusion model.

In an embodiment, bounding boxes and accompanying text may be extracted from raw images which are used for text-image creation. Some embodiments may normalize the bounding box coordinates to a 200 dot per inch (dpi) image space so as to provide consistency among the samples.

In an embodiment, grayscale pseudo pixels may be too limited for the inventive model to learn the necessary semantic information. Accordingly, converting the grayscale pseudo pixel data to a three channel vector format may appropriately enable more accurate reconstruction of text images.

Embodiments of the invention provide a computer-implemented method which may comprise:
a) responsive to input form images, identifying text in the input form images;
b) performing optical character recognition (OCR) to extract the identified text;
c) converting the identified text to text image formatted characters;
d) converting the text image formatted characters to pseudo images;
e) providing said pseudo images to a diffusion model to train said diffusion model; and
f) responsive to outputs of said diffusion model being unsatisfactory, repeating a)-e).

In some embodiments, the method may further comprise:
g) responsive to outputs of said diffusion model being satisfactory:
i. performing text image conversion on said pseudo images;
ii. converting said pseudo images to text within bounding boxes;
iii. identifying text in said bounding boxes;
iv. applying font characteristics to said identified text; and
V. generating further form images.

In some embodiments, the method may further comprise applying style characteristics to said identified text, wherein said generated further form images have applied font type and font size, and said style characteristics are added before said further form images are generated.

In some embodiments, the pseudo images may be one of grayscale or RGB images.

In some embodiments, each of said pseudo images may comprise a plurality of grayscale pseudo pixels, wherein a grayscale value Ri of each of said plurality of pseudo pixels is obtained according to the following:

$${R}_{i} = \frac{{N}_{i}}{M} * 255$$

where
Rᵢ=Grayscale Pixel Value
M=Number of entries in a lookup table comprising an alphabet
Nᵢ=Numerical Value of entry in said lookup table.

Other embodiments may provide a computer-implemented method comprising:
a) performing text image conversion on pseudo images output from a diffusion model;
b) converting said pseudo images to text within bounding boxes;
c) identifying text in said bounding boxes;
d) applying font characteristics to said identified text; and
e) generating further form images.

In some embodiments, font characteristics may be applied to said identified text.

In some embodiments, style characteristics may be applied to said identified text, wherein said generated further form images may have applied font type and font size, and said style characteristics may be added before said further form images are generated.

In some embodiments, the pseudo images may be one of grayscale or RGB images.

In some embodiments, in said converting, said text may comprise text characters from a lookup table having a numerical value for each of said text characters, the pseudo images may comprise pseudo pixels each having a gray scale value, and said text characters may be determined according to the following:

$${N}_{i} = \frac{{R}_{i}}{255} * M$$

where
Nᵢ=Numerical Value of a character in a lookup table
M=Total Size of said lookup table
Rᵢ=Grayscale Pseudo Pixel Value

Embodiments of the invention provide an apparatus for performing the just-listed methods.

### BRIEF DESCRIPTION OF THE DRAWINGS

FIGS. 1A and 1B depict an image to text operation according to an embodiment;

FIG. 2 shows bounding boxes around image portions to be converted to text according to an embodiment;

FIG. 3 depicts reconstruction and conversion of image text to a pseudo image according to an embodiment;

FIG. 4 depicts conversion of characters to numerical values according to an embodiment;

FIG. 5 depicts semantic quantization to convert numerical values to pixel values according to an embodiment;

FIG. 6 is a diagram of a diffusion network design according to an embodiment;

FIG. 7 depicts semantic reconstruction to convert pixel values to characters according to an embodiment;

FIG. 8 is a flow chart depicting aspects of operation according to an embodiment;

FIG. 9 depicts an example of input and pseudo output according to an embodiment;

FIG. 10 is a high level block diagram according to some embodiments;

FIG. 11 is a high level block diagram of portions of FIG. 10 according to an embodiment;

FIG. 12 is a high level block diagram of portions of FIG. 10 according to an embodiment.

### DETAILED DESCRIPTION

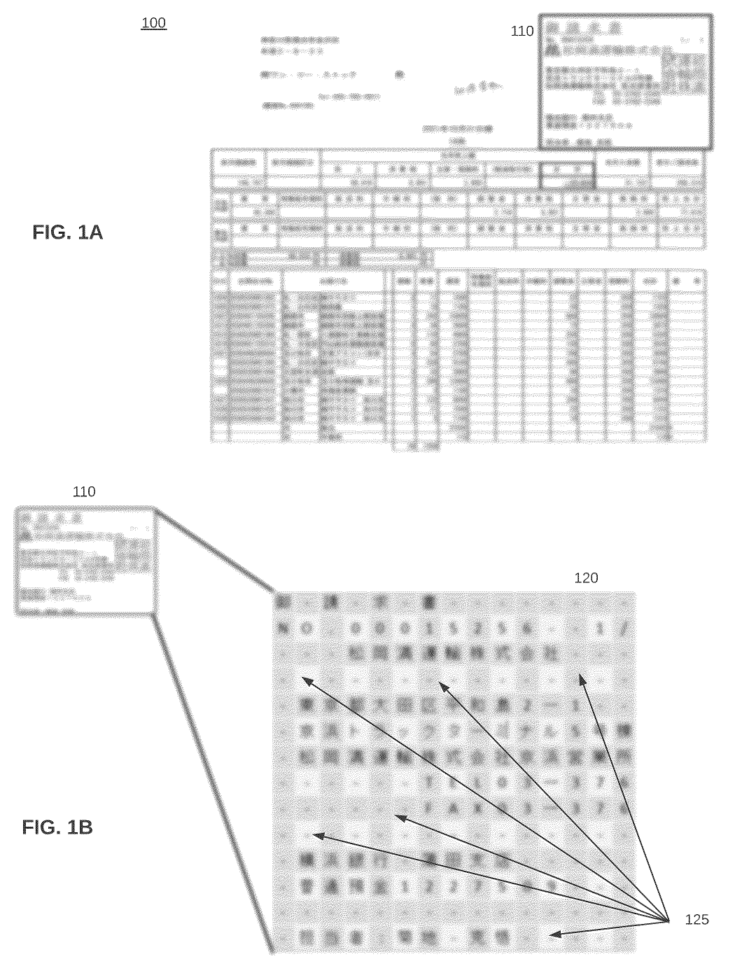

FIG. 1A shows an image of a form 100 with an image sample 110 that is to be converted to text. FIG. 1B shows that image sample 110 expanded to section 120. In an embodiment, the characters in section 120 have the same relative position as in image sample 110. In an embodiment, semantic information about the characters is obtained/extracted, and is associated with the locations from which the information was taken. To preserve the relative positioning and spatial arrangement of the characters, in an embodiment unique characters 125 may be interposed appropriately, as in FIG. 1B.

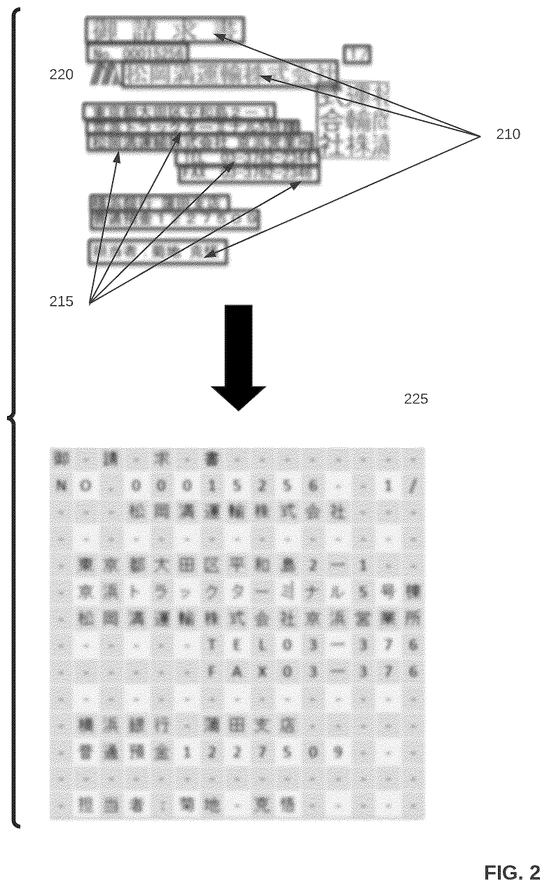

FIG. 2 shows individual image samples 210 from image sample 110 in FIG. 1A, with bounding boxes 215 drawn around them. In an embodiment, characters or symbols such as logo 220 are ignored.

With the bounding boxes 215 surrounding text and numbers, in an embodiment text spotting, which in one form comprises text detection and text recognition, coupled with an optical character reader (OCR) engine may convert the individual image samples 210 into image text, as at 225. Section 220 is basically an image text version of section 120 in FIG. 1B.

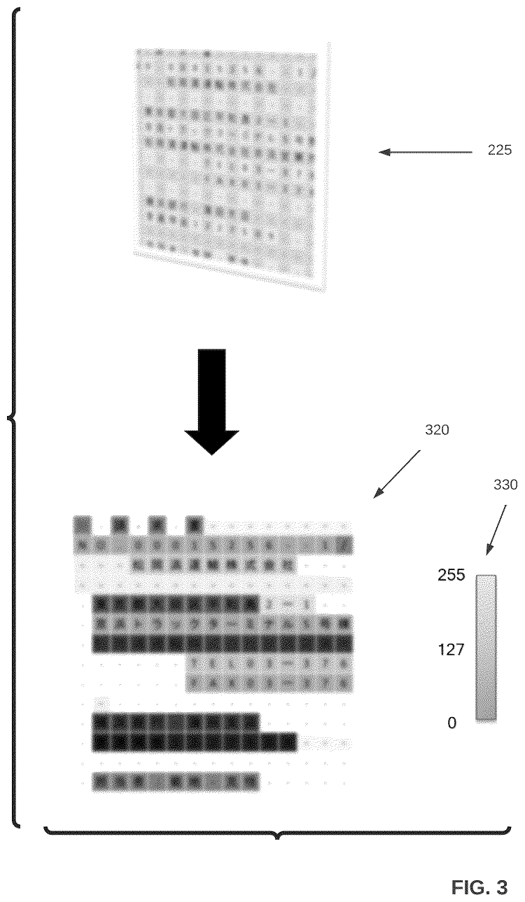

In FIG. 3, section 225 is depicted as being converted to a so-called pseudo image 320. The pseudo image has characters in grayscale pseudo pixels, the grayscale being measured with scale 330.

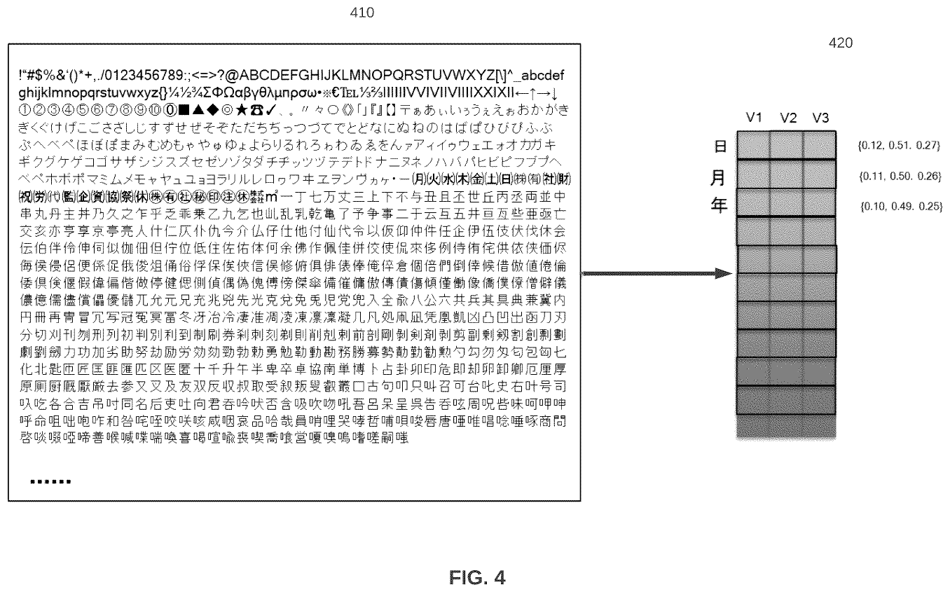

FIG. 4 shows a lookup table 410, to be used in converting characters in the table to numerical values. In an embodiment, the lookup table 410 may contain 4361 characters. The characters in lookup table 410 are largely hiragana, katakana, and kanji, but there are also alphanumeric characters near the top of the table. The lookup table 410 may be considered to represent an alphabet. There can be different alphabets, and hence different lookup tables, for different applications.

In an embodiment, characters with similar meaning may be arranged with the closest vectors or vector embeddings. These are numeric representations of data that may capture certain features of the data. Vector embeddings are one way to convert characters, words, and sentences, among other things, into numbers that capture meanings and relationships. Ordinarily skilled artisans will appreciate that characters and words with similar meanings may be assigned similar numerical values. Ordinarily skilled artisans also will appreciate that the lookup table may be compiled and/or configured differently depending on the application. The application may determine the numerical values assigned to different characters. Different applications may have different numerical assignments.

As noted earlier, grayscale pseudo pixels like the ones in pseudo image 320 may be too limited for a model according to aspects of the present invention to ascertain or learn the necessary semantic information to provide appropriate pseudo output. Accordingly, in an embodiment, the grayscale pseudo pixel image data (individual characters) in pseudo image 320 are converted to a three channel vector format 420. This format may enable more accurate reconstruction of text images.

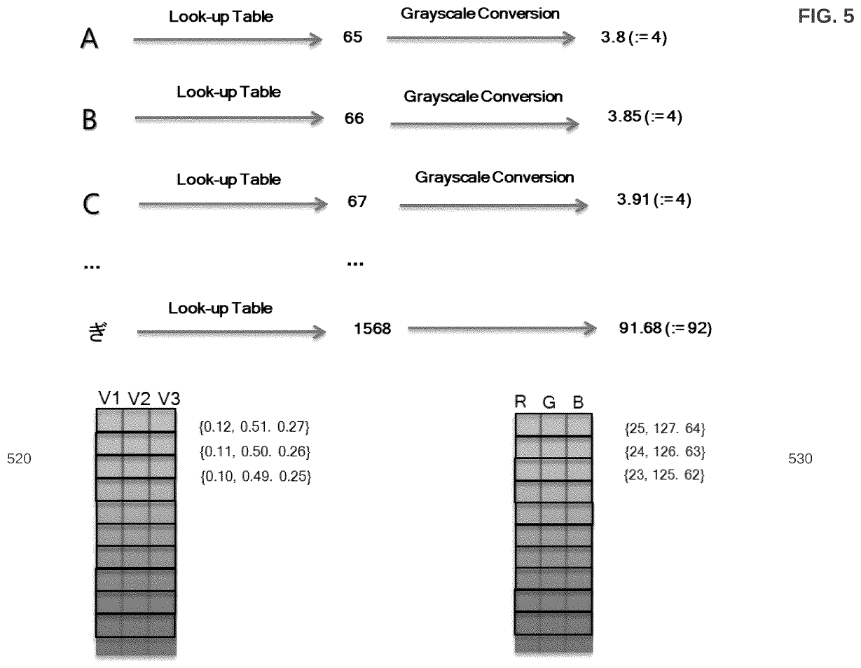

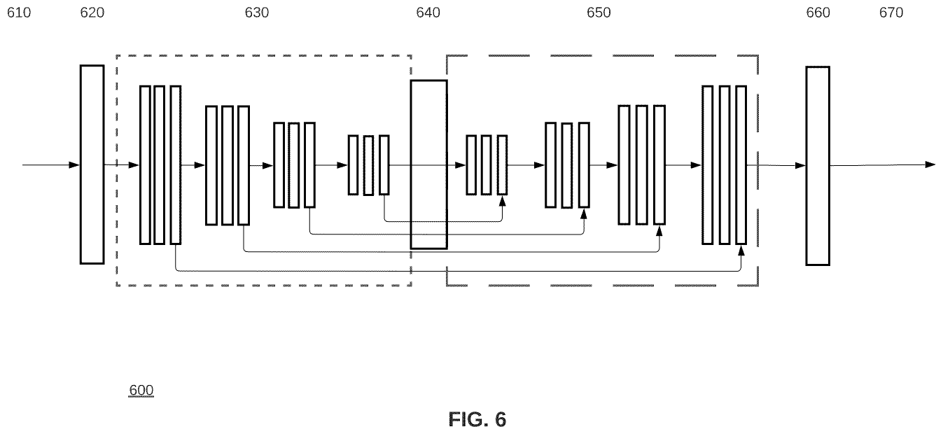

FIG. 5 depicts a process for conversion of numerical values to pixel values, through a process known as semantic quantization. At 510, various characters, including alphabetic characters and kanji, are taken from the lookup table, for example, in FIG. 4. The characters have values assigned to them depending on the desired alphabet, which in turn can depend on the application, as mentioned earlier. In the embodiment being described, A is assigned the numerical value 65, B is assigned 66, C is assigned 67, and [symbol] is assigned 1568. The following formula pertains to calculation of the pixel values:

$${R}_{i} = \frac{{N}_{i}}{M} * 255$$

where
Rᵢ=Grayscale Pseudo Pixel Value
M=Total Alphabet Size
Nᵢ=Numerical Value

In different alphabets, different characters can have different meanings. Consequently, the grayscale values will be different, and will define different gradients for the model being employed. In a sense, an alphabet may be considered to be a kind of dictionary, in which each character maps to a value.

As noted with respect to FIG. 4, in an embodiment there may be 4361 characters in the table. Plugging in that number as the numerical value yields 3.8 as a single channel grayscale pixel value. The values at the right hand side of 510 are single channel pseudo pixel output values. The single channel values can be turned into three channel vector values per 520 in FIG. 5. Those values in turn can undergo RGB conversion, according to an embodiment, yielding three-channel RGB values in 530, recognizing that R, G, and B can range from 0 to 255.

In different alphabets, different characters can have different meanings.

FIG. 6 is a high level diagram of a semantic diffusion network 600 according to an embodiment. In FIG. 6, input text 610 can pass into input network 620, which in an embodiment may be a tensor network. Encoder network 630, which in an embodiment may be a convolutional neural network (CNN), in particular a Resnet network, receives the input from the input network 620. Self-attention mechanism 640 may receive an output of encoder network 630, and may provide inputs to decoder network 650. Outputs of decoder network 650 may pass to output network 660, which also may be a tensor network depending on the embodiment, to yield output 670, which is the generated document image. The tensor output at 670 is the same spatial size as the input image 610. Using the formula below, each tensor value can be converted back within the range [0,255] as a pixel value for display in the generated image.

In an embodiment, a self-attention mechanism based on CNN features may adjust learned weights in encoder network 630 to provide greater weighting to more important features. In an embodiment, correlations among individual pixels may be calculated to enable the weight adjustment. In an embodiment, the self-attention mechanism may include an attention gate module, which can aggregate information from encoder network 630 and upsampled information while adjusting the weights. In an embodiment, the network may utilize a set of implicit reverse attention modules and explicit edge attention guidance to establish a relationship between regions where characters may be localized, and boundaries of the localized characters.

In an embodiment, self-attention mechanism 640 can obtain long-range feature information and adjust the weights of feature points by aggregating correlation information of global feature points. Although embodiments of self-attention mechanisms can improve the deep learning model's recognition accuracy, issues of excessive time, slow training speed, and/or excessively numerous weighting parameters may arise.

Resnet networks can provide a large number of convolutional layers, in some cases, as many as thousands. Common numbers of layers in such networks are 18, 34, 50, 101, and 152. In an embodiment, as many as 101 convolutional layers may be satisfactory.

In an embodiment, an input size to the semantic network may be 224*196, and an output size will be the same, except that in the output, each pixel will be treated as a character. Consequently, the output document will have 224*196 characters for the text, and null characters which represent the spaces. The final output document can be converted and rescaled according to the size of the input, in a range of [0.255] as pixel values for display in the generated image.

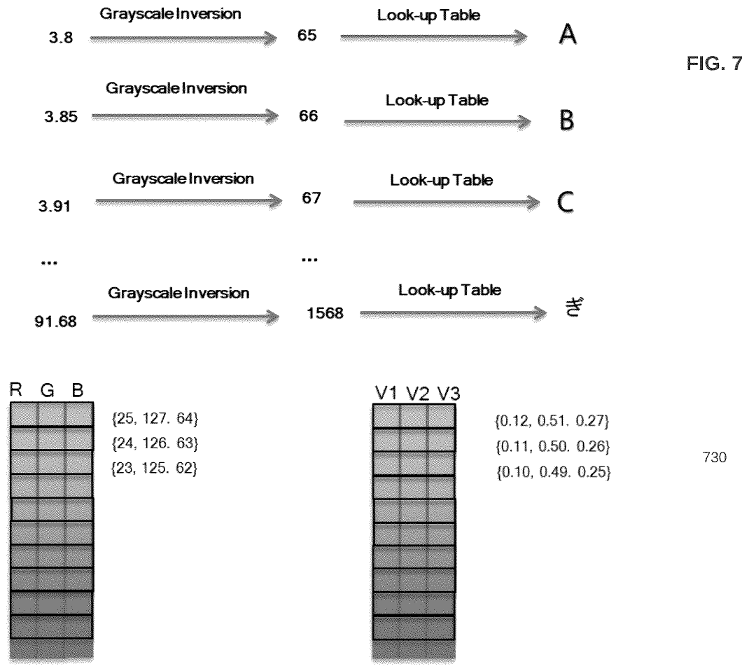

FIG. 7 shows an inverse operation to the one in FIG. 5, converting the numerical values at the right hand side of FIG. 5 into characters in the lookup table. The following formula pertains to numerical value conversion to characters using the grayscale pseudo pixel values from FIG. 5:

$${N}_{i} = \frac{{R}_{i}}{255} * M$$

where
Rᵢ=Grayscale Pseudo Pixel Value
M=Total Alphabet Size
Nᵢ=Numerical Value

Again, as noted with respect to FIG. 4, in an embodiment there may be 4361 characters in the table. Plugging in that value with the grayscale pixel value yields 65, 66, 67, and 1568 as a single channel grayscale pixel value, corresponding to the letters/characters A, B, C, and [symbol] . The right hand side of 710 contains the characters. The numerical value can be turned into three channel RGB vector values per 720 in FIG. 7. Those values in turn can undergo RGB inversion, according to an embodiment, yielding three-channel vector values in 730.

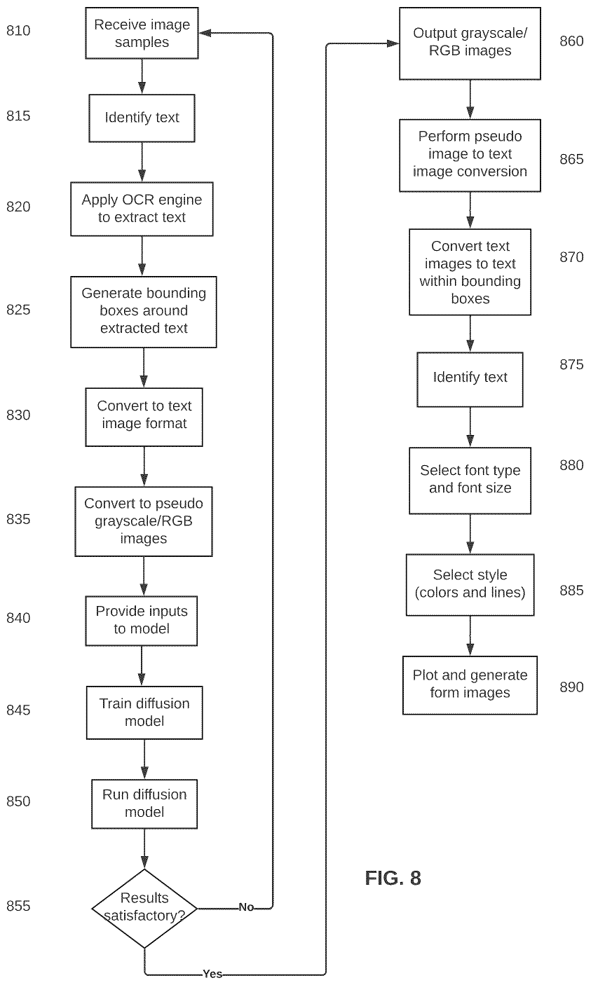

FIG. 8 is a flow chart depicting one sequence of operation of the inventive method and apparatus according to an embodiment. At 810, samples of images are received, as in FIG. 1A. In an embodiment, these samples are samples of invoices or portions of invoices or other financial documents. At 815, text is identified in the image samples, and at 820, optical character recognition (OCR) may be used to extract text from the image samples, as in FIG. 1B. At 825, bounding boxes are provided around the extracted text, similarly to what is shown in FIG. 2. At 830, the text in the bounding boxes is converted to text image, and at 835, the text image data is converted to pseudo grayscale pixel values, using values from a table such as 410 in FIG. 4. The pseudo grayscale pixel values are converted to three-channel RGB images, as in FIG. 5.

At 840 the RGB images are provided as inputs to the model, for example, at 610 in the diffusion network of FIG. 6. The diffusion model is trained at 845, and tested at 850. If the results are not satisfactory, then at 855 flow returns to 810 for more training for the diffusion model. If the results are satisfactory, then at 860, grayscale/RGB images are output. At 865, pseudo image to text image conversion is carried out, as in FIG. 7. At 870, the text images are converted to text within bounding boxes, as an inverse of FIG. 2. Text is identified at 875, and font type and font size are selected at 880. At 885, a style for the text is selected, style relating to colors and types of lines (e.g. italic, bold, underlined). Finally, at 890, form images like form image 100 in FIG. 1A are output.

From the foregoing, ordinarily skilled artisans will appreciate that the overall disclosure here proceeds from creation of training data using existing form images, to training a diffusion model with that training data, to using the diffusion model to generate its own form images.

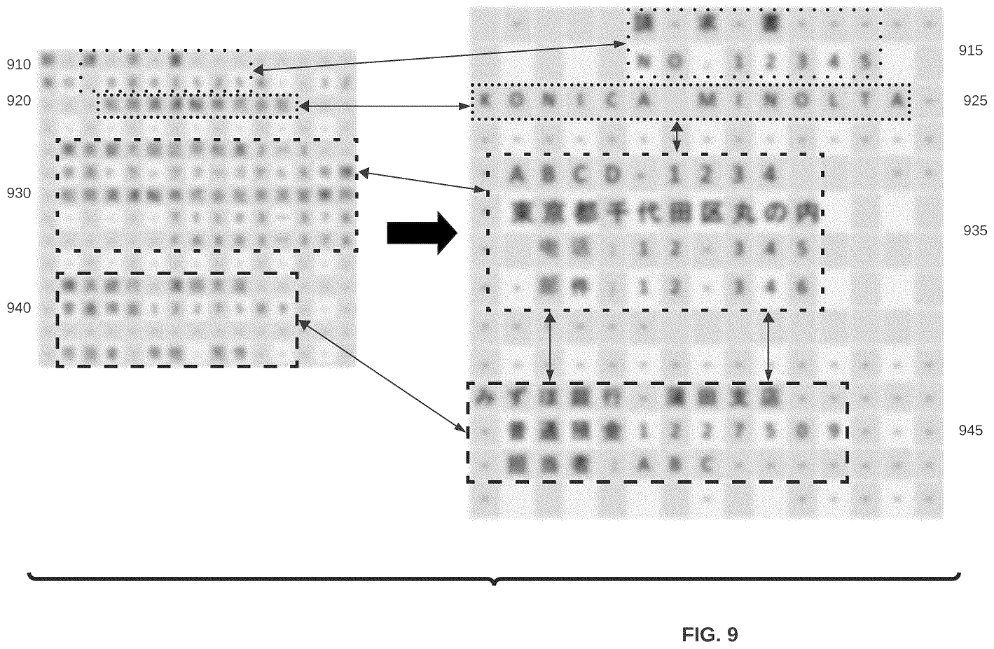

FIG. 9 shows an example of an input from text space, and pseudo pixel output. Each of the blocks 910, 920, 930, and 940 has corresponding outputs at 915, 925, 935, and 945. One aspect of the learning that the inventive system may perform according to an embodiment is learning of similar groups of characters in positions in a form, as for example each of the respective character groups in blocks 910, 920, 930, and 940. Likewise, in an embodiment the system may learn relative positioning between and among pixel locations at the pseudo pixel output, as for example between blocks 915 and 925; 925 and 935; and 935 and 945, respectively.

In embodiments, character based images are 224*192 size tensors, which can encode 224*192 characters for semantic information from original text bounding boxes. These dimensions are flexible, and can be extended to a larger size of input. In an embodiment, in use the 224*192 size achieved about a 0.3 second inference time for each image on the CPU. In order to train the network, it may be necessary to quantize and convert the tensor value from each character using the converter and inverter. In an embodiment, a look-up table of the type discussed earlier, and containing about 4000 characters, may be applied as an alphabet to encode each character. Each character then can be converted to grayscale values [0,255] as pseudo pixels for the model inputs. To gain maximum performance and variability, algorithm-based augmentation may be added to each input bounding box and its corresponding content.

Once the model is trained, it can generate pseudo images which then can be converted back to semi-structured data, such as bounding boxes and characters, to be processed further for creation of digital forms.

Aspects of the present invention provide at least the following advantages. First, the inventive method can generate new structure forms with varied semantic information. The model learns to permute and rearrange the character features for different regions. Second, newly generated forms can be applied to train the semantic model to provide further improvements to the model's capability and generality. Ordinarily skilled artisans will appreciate that this model training and inference is data-driven, thereby avoiding the need for comprehensive post-processing algorithms. The model's training effectively is end to end training, obviating the need for comprehensive post-processing algorithms. Third, the model can generate high quality character-like images that incorporate geometric properties such as character locations and regions of similar meaning, which humans can check and/or interpret.

Aspects of the present invention are suitable for semi-structured data such as forms, tables, and aligned keyword text generation. Embodiments resolve the issue of generating data for mixed and combined geometries and semantics. Embodiments also can be applied to hybrid or multimodality datasets, when the raw data can be interpreted and converted as character-like image tensors.

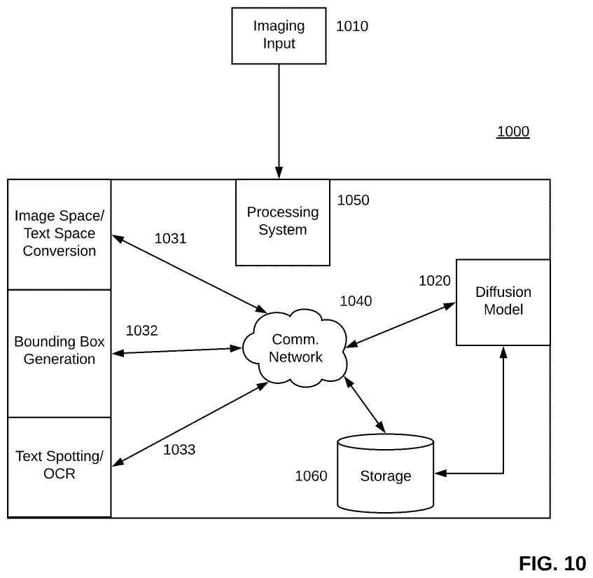

FIG. 10 is a high level block diagram of a computing system 1000 which may implement a diffusion model 1020, trained on known data as discussed above. Depending on the embodiment, form input 1010 may take forms from any number of sources, including not only “live” sources such as scanners, cameras, or other imaging equipment which can provide images of known text sequences, but also “canned” sources such as libraries. In an embodiment, “live” sources as part of form input 1010 also may handle text to be processed for electronic documents.

Processing system 1050 may be a separate system, or it may be part of form input 1010, or may be part of a deep learning system, depending on the embodiment. Processing system 1050 may include one or more processors, one or more storage devices, and one or more solid-state memory systems (which are different from the storage devices, and which may include both non-transitory and transitory memory).

In an embodiment, processing system 1050 may include a deep learning system or may work with a deep learning system to facilitate conversion from image space to text space in block 1031, or bounding box generation in block 1032, or text spotting/OCR in block 1033. In some embodiments, one or more of conversion from image space to text space in in block 1031, or bounding box generation in block 1032, or text spotting/OCR in block 1033 may implement its own deep learning system 1020. In embodiments, each of blocks 1031, 1032, or 1033 may include one or more processors, one or more storage devices, and one or more solid-state memory systems (which are different from the storage devices, and which may include both non-transitory and transitory memory). In embodiments, additional storage 1060 may be accessible to one or more of blocks 1031, 1032, or 1033, and to processing system 1050 over a communications network 1040, which may be a wired or a wireless network or, in an embodiment, the cloud.

In an embodiment, storage 1060 may contain training data for the one or more deep learning systems that may be used in one or more of blocks 1020, 1031, 1032, 1033, or 1050. Storage 1060 may store forms from form input 1010.

Where communications network 1040 is a cloud system for communication, one or more portions of computing system 1000 may be remote from other portions. In an embodiment, even where the various elements are co-located, network 1040 may be cloud-based.

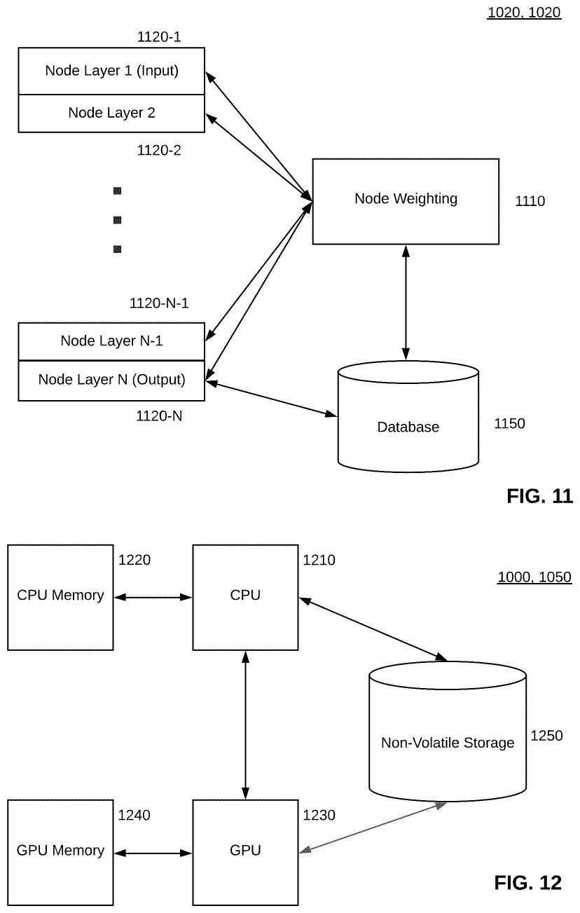

FIG. 11 is a high level diagram of apparatus 1100 for weighting of nodes in the diffusion model according to an embodiment. As training of the diffusion model proceeds according to an embodiment, the various node layers 1120-1, . . . , 1120-N may communicate with node weighting module 1110, which calculates weights for the various nodes, and with database 1150, which stores weights and data. As node weighting module 1110 calculates updated weights, these may be stored in database 1150. This node weighting is part of the diffusion model in FIG. 6, or could be part of any of the deep learning systems that may be used in one or more of the blocks in FIG. 10. As noted earlier, one or more of the blocks in computer system 1000 may implement a deep learning system of its own, and hence may employ node weighting as in FIG. 11.

FIG. 12 is a high level diagram of apparatus 1200 to operate a diffusion model and/or a deep learning system according to an embodiment. In FIG. 12, one or more CPUs 1210 may communicate with CPU memory 1220 and non-volatile storage 1250. One or more GPUs 1230 may communicate with GPU memory 1240 and non-volatile storage 1150. Generally speaking, a CPU may be understood to have a certain number of cores, each with a certain capability and capacity. A GPU may be understood to have a larger number of cores, in many cases a substantially larger number of cores than a CPU. In an embodiment, each of the GPU cores may have a lower capability and capacity than that of the CPU cores, but may perform specialized functions in the deep learning system, enabling the system to operate more quickly than if CPU cores were being used.

In describing embodiments of the invention, the foregoing mentions forms. There may be embodiments in which some documents have sufficiently similar characteristics to forms that the techniques of the invention may be applicable to such documents.

While the foregoing describes embodiments according to aspects of the invention, the invention is not to be considered as limited to those embodiments or aspects. Ordinarily skilled artisans will appreciate variants of the invention within the scope and spirit of the appended claims.

1. A computer-implemented method comprising:
a) responsive to input form images, identifying text in the input form images;
b) performing optical character recognition (OCR) to extract the identified text;
c) converting the identified text to text image formatted characters;
d) converting the text image formatted characters to pseudo images;
e) providing said pseudo images to a diffusion model to train said diffusion model; and
f) responsive to outputs of said diffusion model being unsatisfactory, repeating a)-e).

2. The method of claim 1, further comprising:
g) responsive to outputs of said diffusion model being satisfactory:
i. performing text image conversion on said pseudo images;
ii. converting said pseudo images to text within bounding boxes;
iii. identifying text in said bounding boxes;
iv. applying font characteristics to said identified text; and
V. generating further form images.

3. The method of claim 2, further comprising applying style characteristics to said identified text;
wherein said generated further form images have applied font type and font size, and said style characteristics are added before said further form images are generated.

4. The method of claim 1, wherein the pseudo images are one of grayscale or RGB images.

5. The method of claim 4, wherein each of said pseudo images comprises a plurality of grayscale pseudo pixels, wherein a grayscale value Rᵢ of each of said plurality of pseudo pixels are obtained according to the following:
$${R}_{i} = \frac{{N}_{i}}{M} * 255$$
where
Rᵢ=Grayscale Pseudo Pixel Value
M=Number of entries in a lookup table comprising an alphabet
Nᵢ=Numerical Value of entry in said lookup table.

6. A computer-implemented method comprising:
a) performing text image conversion on pseudo images output from a diffusion model;
b) converting said pseudo images to text within bounding boxes;
c) identifying text in said bounding boxes; and
d) generating further form images.

7. The method of claim 6, further comprising applying font characteristics to said identified text.

8. The method of claim 7, further comprising applying style characteristics to said identified text, wherein said generated further form images have applied font type and font size, and said style characteristics are added before said further form images are generated.

9. The method of claim 6, wherein the pseudo images are one of grayscale or RGB images.

10. The method of claim 9, wherein in said converting, said text comprises text characters from a lookup table having a numerical value for each of said text characters, the pseudo images comprising pseudo pixels each having a gray scale value, said text characters being determined according to the following:
$${N}_{i} = \frac{{R}_{i}}{255} * M$$
where
Nᵢ=Numerical Value of a character in a lookup table
M=Total Size of said lookup table
Rᵢ=Grayscale Pseudo Pixel Value

11. An apparatus comprising:
at least one processor; and
at least one non-transitory memory that contains instructions that, when executed, enable the at least one processor to perform a method comprising:
a) responsive to input form images, identifying text in the input form images;
b) performing optical character recognition (OCR) to extract the identified text;
c) converting the identified text to text image formatted characters;
d) converting the text image formatted characters to pseudo images;
e) providing said pseudo images to a diffusion model to train said diffusion model;
f) responsive to outputs of said diffusion model being unsatisfactory, repeating a)-e).

12. The apparatus of claim 11, wherein the method further comprises:
g) responsive to outputs of said diffusion model being satisfactory:
i. performing text image conversion on said pseudo images;
ii. converting said pseudo images to text within bounding boxes;
iii. identifying text in said bounding boxes;
iv. applying font characteristics to said identified text; and
V. generating further form images.

13. The apparatus of claim 12, further comprising applying style characteristics to said identified text;
wherein said generated further form images have applied font type and font size, and
said style characteristics are added before said further form images are generated.

14. The apparatus of claim 11, wherein the pseudo images are one of grayscale or RGB images.

15. The apparatus of claim 14, wherein each of said pseudo images comprises a plurality of grayscale pseudo pixels, wherein a grayscale value Rᵢ of each of said plurality of pseudo pixels are obtained according to the following:
$${R}_{i} = \frac{{N}_{i}}{M} * 255$$
where
Rᵢ=Grayscale Pixel Value
M=Number of entries in a lookup table comprising an alphabet
Nᵢ=Numerical Value of entry in said lookup table.

16. The apparatus of claim 11, wherein the method further comprises:
g) responsive to outputs of said diffusion model being satisfactory:
i. performing text image conversion on pseudo images output from a diffusion model;
ii. converting said pseudo images to text within bounding boxes;
iii. identifying text in said bounding boxes; and
iv. generating further form images.

17. The apparatus of claim 16, wherein the method further comprises applying font characteristics to said identified text.

18. The apparatus of claim 17, wherein the method further comprises applying style characteristics to said identified text, wherein said generated further form images have applied font type and font size, and said style characteristics are added before said further form images are generated.

19. The apparatus of claim 16, wherein the pseudo images are one of grayscale or RGB images.

20. The apparatus of claim 19, wherein in said converting, said text comprises text characters from a lookup table having a numerical value for each of said text characters, the pseudo images comprising pseudo pixels each having a gray scale value, said text characters being determined according to the following:
$${N}_{i} = \frac{{R}_{i}}{255} * M$$
where
Nᵢ=Numerical Value of a character in a lookup table
M=Total Size of said lookup table
Rᵢ=Grayscale Pseudo Pixel Value
